(19) United States
(12) Patent Application Publication
(10) Pub. No.: US 2009/0063280 A1
(43) Pub. Date: Mar. 5, 2009

(54) Delivering Merged Advertising and Content for Mobile Devices

(76) Inventors: Charles Stewart Wurster, San Diego, CA (US); Sachin Deshpande, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/204,618

(22) Filed: Sep. 4, 2008

Related U.S. Application Data
(60) Provisional application No. 60/969,919, filed on Sep. 4, 2007.

(51) Int. Cl. G06Q 30/00

(52) U.S. Cl. 705/14

(57) ABSTRACT

A request to initiate delivery of content via a messaging services protocol to a mobile phone can be received. Thereafter, content and one or more advertisements associated with the request can be obtained. The content and the one or more advertisements can optionally be converted into a baseline format. The content and the one or more advertisements can be integrated to generate an integrated media file, the integrated media file substantially conforming to content delivery specifications for the mobile phone. Thereafter, delivery of a packet data unit encapsulating the integrated media file to the mobile phone via the messaging services protocol can be initiated. In some variations, the integrated media file can be modified to make it actionable. Related apparatus, systems, techniques and articles are also described.

### RELATED APPLICATION

This application claims priority to U.S. Pat. App. Ser. No. 60/969,919 filed on Sep. 4, 2007, the contents of which are hereby fully incorporated by reference.

### TECHNICAL FIELD

The subject matter described herein relates to the delivery of merged advertisement and content to mobile devices such as mobile phones.

### BACKGROUND

Over the past few years, there has been an explosive growth of messaging (particularly Short Messaging Service SMS) on mobile phones. This explosive growth began in Europe and Asia and has recently crossed-over into the United States. SMS has become so popular that many carriers now report their monthly messaging volume on their quarterly financial update press releases. However, SMS is limited to text. And as mobile devices are becoming increasingly sophisticated, the delivery of compelling rich media has now become possible.

Multimedia Messaging Service (commonly known as MMS) is a recent form of messaging that enables the delivery of rich media including video, audio, picture images, and more. According to TechWeb, MMS is defined as an enhanced transmission service that enables graphics, video clips and sound files to be transmitted via cellphones.

Content providers are looking for new ways to utilize and monetize their inventory. One particularly compelling way to monetize multimedia content is to include advertising in the multimedia content to enable subsidized content delivery. The most widely accepted method of combining video content and advertising is seen in television programming and on the Internet. An advertisement in the same format as the video program is spliced into the video program; this can be done as a pre-stitial, post-stitial, or intersititial. On the mobile platform, particularly MMS, the size of the content delivered is often highly constrained. Given a hypothetical length restriction of 30 seconds or video dedicating such a pre-stitial, post-stitial, or interstitial advertisement (i.e. such as a 10 second video advertisement) may not be desirable. Additionally, when delivering image content it is useful to be able to present an advertisement in a relatively non-intrusive way. In order to overcome these issues the current subject matter allows the advertisements to be included in the content without needing to take over the whole screen.

### SUMMARY

In one aspect, a request to initiate delivery of content via a messaging services protocol to a mobile phone is received. In response to the request, the content is obtained as well as one or more advertisements associated with the request. Thereafter, the content and the one or more advertisements are converted into a baseline format. The baseline format content and the one or more baseline format advertisements are integrated to generate an integrated media file. The integrated media file is made to substantially conform to content delivery specifications for the mobile phone. Subsequently, delivery of a packet data unit encapsulating the integrated media file to the mobile phone via the messaging services protocol can be initiated.

The messaging services protocol can be, for example, Short Messaging Service or Multimedia Messaging Service. One or more messages can be delivered depending on the messaging service utilized as well as the size of the integrated media file (in some cases a link to the integrated media file could be provided or the integrated media file could be partitioned over several messages).

The advertisements can take many forms and can be displayed in a variety of ways on the mobile phone. For example, at least one of the advertisements can be pre-pended to the video content so that such advertisement or advertisements are displayed prior to the video content when the integrated media file is played on the mobile phone. At least one of the advertisements can be appended to the video content so that such advertisement or advertisements are displayed subsequent to the video content when the integrated media file is played on the mobile phone. At least one of the advertisements can be displayed concurrently to the video content when the integrated media file is played on the mobile phone. The advertisements can be placed along an outer edge of the screen of the mobile phone. The advertisements can overlay at least a portion of the content and can optionally be transparent. A first of at least one of the advertisements can be displayed prior to a first clip of the video content, a second of the at least one of the advertisements can be displayed subsequent to the video content, and a second clip of the video content can be played subsequent to the second portion of the at least one of the advertisements when the integrated media file is played on the mobile phone.

Content delivery specifications for the mobile phone can be determined for the mobile phone by associating the mobile phone with a device class. The device class can, for example, prescribe video resolution limitations for a group of mobile phones. A codec to encode the video content and the advertisement can be selected based on the video resolution limitations prescribed by the associated device class for the mobile phone. In addition or in the alternative, one or more content delivery specifications can be determined for the mobile phone by predicting video settings for the mobile phone based on one or more of characteristics derived from metadata of the video content, previous encodings of the video content, such previous encodings being below a predetermined performance threshold, and/or performance characteristics for the mobile phone.

Obtaining the video content can comprise polling a source media database to obtain the requested video content. The obtained video content can comprise at least two video clips having different display settings. One or more of the video clips can have different durations. Obtaining the advertisement associated with the request can comprise polling an advertising media database to obtain the associated advertisement. Polling the advertising media database can comprises associating one or more of the mobile phone and the requested video content with at least one key word and querying the advertising media database with the at least one key word to obtain a matching advertisement.

Content delivery specifications can include, for example, media player resolution, file formats supported, video formats supported, video codecs supported, video bit rates supported, video frame rates supported, acceptable video key frame positioning, audio formats supported, audio codecs supported, audio data rates supported, audio channels supported, audio sample rate supported, maximum media time length supported, and/or maximum media file size supported.

In some variations, actionable code to solicit one or more actions by a user of the mobile phone can be generated for inclusion in the packet data unit. This actionable code may be inserted into the body of the message, inserted into the integrated media file, or included alongside the integrated media file. Actionable code can, for example, comprise statements describing how a user can respond (e.g., obtain complementary information, etc.) to the integrated media file and the like. The integrated media file and/or the actionable code can be compressed in the packet data unit.

The packet data unit can comprise a descriptor file including a message soliciting one or more actions by a user of the mobile phone when playing the integrated media file or when viewing the message.

In an interrelated aspect, a request to initiate delivery of media content via a messaging services protocol to a mobile phone is received. Thereafter, the media content is obtained as well an advertisement associated with the request. One or more content delivery specifications for the mobile phone and at least a portion of the media content with at least a portion of the advertisement can be combined to generate an integrated media file. The integrated media file substantially conforms to the determined content delivery specifications for the mobile phone. Thereafter, a packet data unit encapsulating the integrated media file and actionable code is generated. The actionable code solicits one or more actions by a user of the mobile phone when playing the modified integrated media file. After the packet data unit is generated, delivery of the packet data unit to the mobile phone via the messaging services protocol is initiated.

In a further interrelated aspect, a request to initiate delivery of media content via a messaging services protocol to a mobile phone is received. Thereafter, the media content and an advertisement associated with the request are obtained. One or more content delivery specifications for the mobile phone are determined so that at least a portion of the media content can be combined with at least a portion of the advertisement to generate an integrated media file that conforms to the determined content delivery specifications for the mobile phone. The integrated media file can be persisted in a WAP accessible location so that delivery of a URL pointing to the WAP accessible location via the messaging services protocol to the mobile phone can be initiated.

In yet another interrelated aspect, a request to initiate delivery of media content via a messaging services protocol to a mobile phone is received. The media content and an advertisement associated with the request are obtained. Delivery specifications for the mobile phone are then determined. At least a portion of the media content are combined with at least a portion of the advertisement to generate an integrated media file that substantially conforms to the determined content delivery specifications for the mobile phone. The integrated media file is later modified to include actionable code that solicits one or more actions by a user of the mobile phone when playing the modified integrated media file. Delivery of a packet data unit via the messaging services protocol can then be initiated, the packet data unit encapsulating data enabling the modified integrated media file to be played on the mobile phone.

In such a variation, the packet data unit can comprise the integrated media file or it can comprise a URL pointing to a persisted version of the integrated media file, the URL, when activated, causing the integrated media file to be played on the mobile phone.

In yet another interrelated aspect, a request to initiate delivery of media content to a mobile phone is received which results in the media content and an advertisement associated with the request being obtained. One or more content delivery specifications for the mobile phone are later determined. At least a portion of the media content is combined with at least a portion of the advertisement to generate an integrated media file that substantially conforms to the determined content delivery specifications for the mobile phone. Actionable code associated with the integrated media file that solicits one or more actions by a user of the mobile phone when playing the modified integrated media file can be generated. Thereafter, delivery of data enabling the mobile phone to play the integrated media file with the actionable code to the mobile phone can be initiated.

In yet a further interrelated aspect, a request to initiate delivery of media content to a mobile phone can be received. One or more content delivery specifications for the mobile phone can be specified. Subsequently, the content delivery specifications can be associated with a selected one of a plurality of previously generated integrated media files. The selected integrated media file can include a combination of the media content and at least one advertisement and it can substantially conform to the determined content delivery specifications for the mobile phone. Lastly, delivery of data enabling the mobile phone to play the integrated media file to the mobile phone can be initiated.

Articles are also described that comprise a machine-readable storage medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. For example, the current subject matter allows for an advertisement that is intended to be much smaller than the total screen on a mobile device to be combined with various types of media. The combination of the advertisement(s) with content can be accomplished in a variety of ways including layering the advertisement on the media thus obscuring part of the video (i.e., it is possible to allow the original media to show through the advertisement by making the advertisement transparent to some degree), or resizing the video to make room for the advertisement. The media and the advertisement may be merged to create a single media file. This media file may then be distributed to handsets using MMS, SMS, WAP, web link, or some other delivery method.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating the generation and delivery of an integrated media file;

FIG. 2 is a diagram illustrating modules for generating and delivering an integrated media file;

FIG. 3 is a diagram illustrating modules for generating and delivering an integrated media file; and

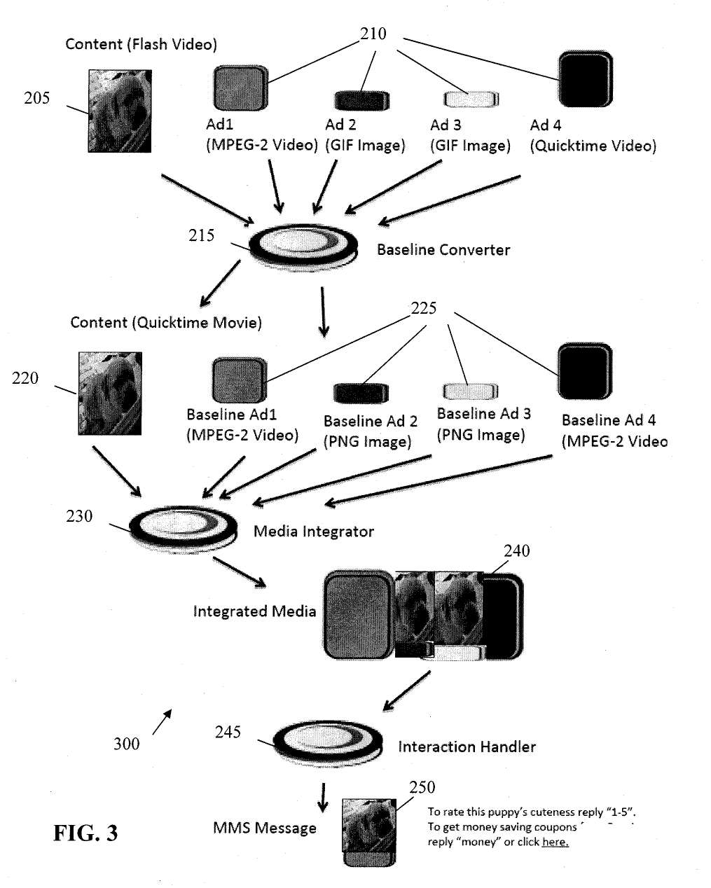

FIG. 4 is a process flow diagram illustrating the delivery of a previously generated integrated media file.

Like reference symbols in the various drawings indicate like elements.

### DETAILED DESCRIPTION

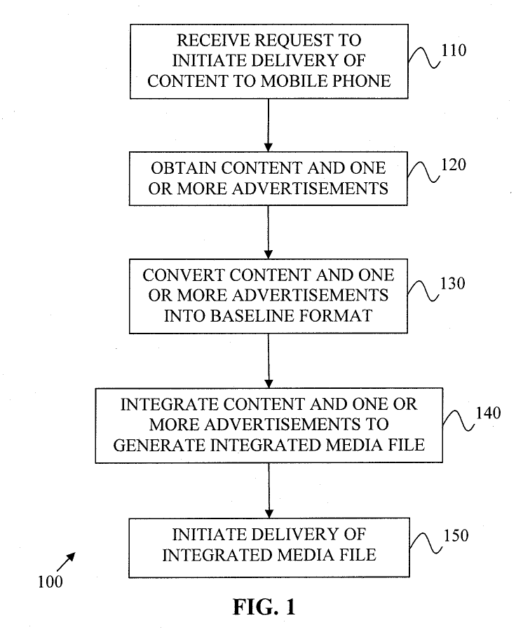

FIG. 1 is a process flow diagram illustrating a method 100, in which, at 110, a request to initiate delivery of content via a messaging services protocol to a mobile phone is received. Content and one or more advertisements associated with the request are, at 120, then obtained (the content and advertisements can be obtained in sequence or in parallel in any order). In some implementations, at 130, the content and the one or more advertisements are converted into a baseline format. Thereafter, the content and the one or more advertisements are integrated, at 140, to generate an integrated media file that substantially conforms to content delivery specifications for the mobile phone. Delivery of a packet data unit encapsulating the integrated media file to the mobile phone via the messaging services protocol can later, at 150, be initiated.

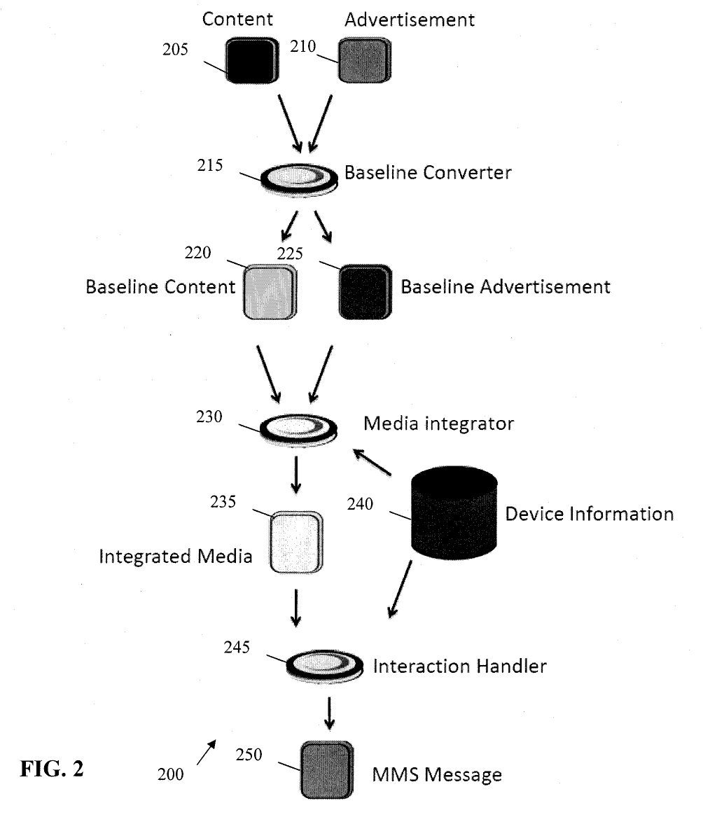

FIG. 2 is a diagram 200 that illustrates an arrangement in which content 205 and an advertisement 210 can be combined to form an MMS message 250. The content 205 and advertisement 210 can optionally be converted into a standard baseline format using a baseline converter 215. While baseline conversion is not required, it can, in most cases make merging different formats of content 205 and advertisement 210 significantly easier. For example, it is difficult to perform manipulations to combine content 205 and an advertisement 210 if one is encoded as a Windows Media File and another is encoded as a Quicktime Movie without bringing them to a standard form. Some programs exist that can combine dissimilar formats, however, such programs typically bring content 205 and advertisement 210 to uncompressed frames in order to perform manipulations. For the purpose of inserting advertising 210 into content 205, it can be helpful to the underlying data formats, especially video in the same format and scale so that different combinations of content 205 and advertising 210 can be quickly performed. Bringing divergent media formats to the uncompressed domain to perform manipulations is more computationally intensive.

Once the content 205 and advertisement 210 are in a common baseline format (respectively referred to as baseline content 220 and baseline advertisement 225) it can be manipulated. Given a piece of baseline content 220 and a baseline advertisement 225, a merge of such media can be performed. As stated above, it can be possible to perform such a merging without bringing the media to a baseline format. The merging can be performed by a media integrator 230 to result in an integrated media file 235. If any of the media is video then the generated integrated media file 235 can, in most cases, be a video file, otherwise it is likely to be an image. The media integrator 230 can be coupled to a device information database 240.

A device information database 240 can be used to provide contextual information to effect such a combination. The device information database 240 can include information such as: MMS player resolution, file formats supported, video formats supported, video codecs supported, video bitrates supported, video frame rates supported, acceptable video key frame positioning, audio formats supported, audio codecs supported, audio data rates supported, audio channels supported, audio sample rate supported, maximum media time length supported, maximum media file size supported, for the each mobile device/carrier pair, and the like. The device information database 240 can be helpful in order to optimize the delivery of content and advertisements to a mobile phone (techniques for delivering media to mobile devices are described in U.S. patent application Ser. No. 12/053,093 entitled: “Optimized Messaging Service-Based Media Delivery”, the contents of which are hereby incorporated by reference). Due to the complexity of the mobile device marketplace, a given mobile device may have different characteristics depending on the mobile carrier that it is sold by, especially in the US where carriers customize the devices in an effort to add differentiating services. Additionally, the carriers may introduce limitations on the content that they are willing to carry over their network independent of the capabilities of the mobile device. By having the device information database 240 include all (or substantially all) of the mobile device models, and taking into account the variations introduced by the carrier, one can ensure that media generated for a mobile device will be accessible on that device. It is also important to note that the device characteristics may not match that device's application characteristics (for example the MMS client's media players may support only a subset of the formats that the device supports in general).

The media integrator 235 takes the baseline content 220 and baseline advertisement 225 and determine how they should be integrated. The content can be integrated in a number of ways including but not limited to: placing the ad along the edge (top, bottom, left, right) of the content and resizing the content to make room for it, placing the ad along the edge (top, bottom, left, right) of the content and overwriting a portion of the content, placing the ad anywhere on the screen overwriting the content with (or without) a transparency set on the ad to allow some portion of the content to show through. The advertisement can appear for some or all of the video (for example, the advertisement may fade in and out).

Additionally the media integrator 230 can include full size advertisements as well as advertisements that are not meant to take over the whole screen of a mobile device. In this case, the full screen advertisement may be inserted as a pre-stitial, post-stitial, or intersititial. There can also be cases in which multiple advertisements are integrated into a video; furthermore these advertisements can be different sizes ranging from portions of the screen all the way to full screen advertisements. In addition, the media integrator 230 can provide for multiple advertisements to simultaneously appear on a screen of a mobile device. The media integrator 230 can also provide support for the handing of the “finish frame” of the video. On some devices when a video is done playing the finish frame is the last frame of the video, while on other devices the media player reverts to the first frame of the video once the video is done. For advertising purposes it may be important to know which frame stays on the screen when the video has finished playing since this frame may spend a disproportionate amount of time on the screen.

Once the integrated media file 235 has been generated, it can be incorporated into a MMS message 250 or some other delivery mechanism (e.g., series of segmented SMS messages which can be reconstructed/reassembled on mobile device, SMS message with a hyperlink to the integrated media file, etc.). For some messages it may be useful to pass the integrated media file 235 to an interaction handler 245.

The interaction handler 245 can take into account the abilities of the target mobile device from the device information database 240 in order, for example, to insert into the messages information that can be interpreted by the mobile device as actionable (link to a web site, phone number, link to an application, etc.). The interaction handler 245 can also encapsulate the integrated media 235 file within another format (e.g. zip, tar, etc.) with or without additional files. The interaction handler 245 can incorporate the integrated media file 235 into an MMS message by using a descriptor file created in one of a number of descriptor languages (e.g. SMIL (Synchronized Multimedia Integration Language), XML (Extensible Markup Language), a custom manifest file, etc.) that references the integrated media. The interaction handler 245 can take into account the abilities of the target mobile device from the device information database 240 in order, for example, to insert into the descriptor file information that can be interpreted by the mobile device as actionable (link to a web site, phone number, link to an application, etc.).

Additionally the interaction handler 245 can record the message, its content, and its advertisements so that if an end user was to reply to the message the user and the desired interaction can be identified. For example, a message could include content for which it is possible to rate the content by replying to the message with a rating, for example 1 to 5, and an advertisement that allows the user to request more information by replying “more”. Depending on the body of the message that the user sends back with their reply, the interaction handler 245 can determine if the reply is in reference to the content or the advertisement and perform the requested action.

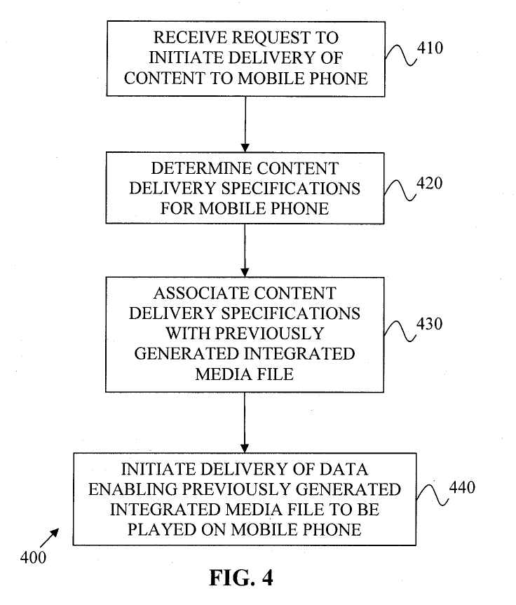

In one example illustrated in FIG. 4, content 205 and one or more advertisements 210 in any number of formats including Windows Media, QuickTime, Flash, MPEG-2, MPEG-4, Real, AVI, PGN, Windows Bitmap, JPEG, and GIF are sent to the baseline converter 215. The baseline converter 215 takes the content 205 and advertisement(s) 210 video files and converts them to QuickTime movies with the MPEG4 video codec, the AAC audio codec, and a resolution of 320 by 240. The content images 205 are converted to PNG with a resolution of 320 by 240. The baseline converter 215 takes video advertisement files and scales them so that neither their width nor height exceeds 320 by 240 while maintaining the aspect ratio. The advertising images 210 are converted as described above if they are intended to accompany video content and are scaled so that neither their width nor height exceeds 320 by 240 while maintaining the aspect ratio if they are intended to accompany image content.

These baseline media 220, 225 are then manipulated by the media integrator 230. For an example case in which the content is a video that is 320×240, the first ad is a video that is 320×240, the second ad is an image that is 320×32, the third ad is an image that is 320×32, and fourth ad is a video that is 320×240; and the desired final media is a video which is 320×240 with the first advertisement running full screen before the content, the next advertisement running at the bottom of the screen (without obscuring the video) from frame 0 to 600, the next advertisement running at the bottom of the screen (without obscuring the video) from frame 600 to the last frame, and the last advertisement running full screen after the content, the media integrator 230 can perform the following actions. First, the desired sizes of the advertisements are computed and if necessary the advertisements resized (in this example the advertisements are already appropriately sized). Second, the advertising images are converted into a video with the appropriate number of frames. Third, the video content is resized so that its height is the standard height of the video (320) minus the height of the advertisement (32), resulting in a new video that is (320×208) Fourth, the five videos are combined to create a new video that includes all of the elements. Lastly, the media integrator 230 takes the resulting video and encodes it for delivery to a mobile device (for example, as a 3g2 file).

The integrated media 235 can then be sent to the interaction handler 245. Depending on the capabilities of the mobile device, the interaction handler 245 takes the media and inserts information into the message that will be delivered. In this example, the target device is one that accepts MMS messages and web links. The interaction handler 245 inserts into the body of the message instructions on how to reply to the message to rate the content and how to reply to the message to get more information about the advertisement. Additionally, the interaction handler 245 creates a web link that the user of the mobile device can activate to get more information from the advertiser if the device is capable of supporting web links and inserts it into the message. Otherwise the interaction handler 245 inserts into the message information on how to reply to the message to get more information from the advertiser (e.g., text COUPON to short code 55555, etc.).

While the foregoing describes variations in which the advertisements can be associated with the content and the integrated media file can be generated on-the-fly/dynamically, it will also be appreciated that the techniques described herein can be used when there are a plurality of previously generated integrated media files. With such an arrangement, the previously generated integrated media files can be optimized for certain classes of mobile phones (those classes having similar content delivery specifications).

FIG. 4 is a process flow diagram illustrating such an arrangement. FIG. 4 includes a method 400, in which, at 410, a request to initiate delivery of media content to a mobile phone is received. At 420, one or more content delivery specifications for the mobile phone is specified. Subsequently, the content delivery specifications is associated, at 430, with a selected one of a plurality of previously generated integrated media files. The selected integrated media file can include a combination of the media content and at least one advertisement and it can substantially conform to the determined content delivery specifications for the mobile phone. Lastly, at 440, delivery of data enabling the mobile phone to play the integrated media file to the mobile phone is initiated.

Such data can be delivered in a variety of forms including, without limitation, by e-mail or messaging service. Actionable code associated with the integrated media file that solicits one or more actions by a user of the mobile phone when playing the modified integrated media file can be included in the delivered data.

The data can comprise a URL pointing to the selected integrated media file. When the URL is activated by the user (or automatically by the mobile phone), contextual information can be used (e.g., header information) to identify the mobile phone. Prior to the selected integrated media file being loaded to the mobile phone, it can be determined whether the selected integrated media file is optimized for the identified mobile phone. If so, the selected integrated media file can be delivered to the mobile phone. Otherwise, an alternative integrated media file can be provided to the mobile phone that is optimized based on the newly identified mobile phone information.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and, in some implementations, a pointing device (e.g., arrow keys, a mouse, a trackball, etc.) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method comprising:
receiving a request to initiate delivery of content via a messaging services protocol to a mobile phone;
obtaining the content;
obtaining one or more advertisements associated with the request;
converting the content and the one or more advertisements into a baseline format;
integrating the baseline format content and the one or more baseline format advertisements to generate an integrated media file, the integrated media file substantially conforming to content delivery specifications for the mobile phone; and
initiating delivery of a packet data unit encapsulating the integrated media file to the mobile phone via the messaging services protocol.

2. A method as in claim 1, wherein the messaging services protocol is Multimedia Messaging Service.

3. A method in claim 1, wherein at least one of the advertisements is pre-pended to the video content so that such advertisement or advertisements are displayed prior to the video content when the integrated media file is played on the mobile phone.

4. A method as in claim 1, wherein at least one of the advertisements is appended to the video content so that such advertisement or advertisements are displayed subsequent to the video content when the integrated media file is played on the mobile phone.

5. A method as in claim 1, wherein at least one of the advertisements is displayed concurrently to the video content when the integrated media file is played on the mobile phone.

6. A method as in claim 1, wherein the at least one concurrently displayed advertisement is placed along an outer edge of a screen of the mobile phone.

7. A method as in claim 1, wherein the at least one concurrently displayed advertisement is overlaid on top of at least a portion of the video content.

8. A method as in claim 1, wherein a transparency level of the at least one concurrently displayed advertisement overlaid on top of at least a portion of the video content varies at the video content is being played.

9. A method in claim 1, wherein a first of at least one of the advertisements is displayed prior to a first clip of the video content, a second of the at least one of the advertisements is displayed subsequent to the video content, and a second clip of the video content is played subsequent to the second portion of the at least one of the advertisements when the integrated media file is played on the mobile phone.

10. A method as in claim 1, further comprising determining one or more content delivery specifications for the mobile phone by associating the mobile phone with a device class, the device class prescribing video resolution limitations for a group of mobile phones.

11. A method as in claim 10, further comprising:
selecting a codec to encode the video content and the advertisement based on the video resolution limitations prescribed by the associated device class for the mobile phone.

12. A method as in claim 1, further comprising determining one or more content delivery specifications for the mobile phone by predicting video settings for the mobile phone based on one or more of characteristics derived from metadata of the video content, previous encodings of the video content, such previous encodings being below a predetermined performance threshold, and performance characteristics for the mobile phone.

13. A method as in claim 1, wherein the obtaining the video content comprises:
polling a source media database to obtain the requested video content.

14. A method as in claim 1, wherein the obtained video content comprises at least two video clips having different display settings.

15. A method as in claim 14, wherein at least a subset of the video clips have different durations.

16. A method as in claim 1, wherein obtaining the advertisement associated with the request comprises:
polling an advertising media database to obtain the associated advertisement.

17. A method as in claim 16, wherein polling the advertising media database comprises:
associating one or more of the mobile phone and the requested video content with at least one key word; and
querying the advertising media database with the at least one key word to obtain a matching advertisement.

18. A method as in claim 1, wherein one or more of the content delivery specifications are selected from a group comprising: media player resolution, file formats supported, video formats supported, video codecs supported, video bit rates supported, video frame rates supported, acceptable video key frame positioning, audio formats supported, audio codecs supported, audio data rates supported, audio channels supported, audio sample rate supported, maximum media time length supported, and maximum media file size supported.

19. A method as in claim 1, further comprising generating actionable code to solicit one or more actions by a user of the mobile phone for inclusion in the packet data unit.

20. A method as in claim 20, wherein the integrated media file and the actionable code are compressed in the packet data unit.

21. A method as in claim 1, wherein the packet data unit comprises a descriptor file including a message soliciting one or more actions by a user of the mobile phone when playing the integrated media file or when viewing the message.

22. A computer-implemented method comprising:
receiving a request to initiate delivery of media content via a messaging services protocol to a mobile phone;
obtaining the media content;
obtaining an advertisement associated with the request;
determining one or more content delivery specifications for the mobile phone;
combining at least a portion of the media content with at least a portion of the advertisement to generate an integrated media file, the integrated media file substantially conforming to the determined content delivery specifications for the mobile phone;
generating a packet data unit encapsulating the integrated media file and actionable code, the actionable code soliciting one or more actions by a user of the mobile phone when playing the modified integrated media file; and
initiating delivery of the packet data unit to the mobile phone via the messaging services protocol.

23. A computer-implemented method comprising:
receiving a request to initiate delivery of media content via a messaging services protocol to a mobile phone;
obtaining the media content;
obtaining an advertisement associated with the request;
determining one or more content delivery specifications for the mobile phone;
combining at least a portion of the media content with at least a portion of the advertisement to generate an integrated media file, the integrated media file substantially conforming to the determined content delivery specifications for the mobile phone;
persisting the integrated media file in a WAP accessible location; and
initiating delivery of a URL pointing to the WAP accessible location via the messaging services protocol to the mobile phone.

24. A computer-implemented method comprising:
receiving a request to initiate delivery of media content via a messaging services protocol to a mobile phone;
obtaining the media content;
obtaining an advertisement associated with the request; one or more content delivery specifications for the mobile phone;
combining at least a portion of the media content with at least a portion of the advertisement to generate an integrated media file, the integrated media file substantially conforming to the determined content delivery specifications for the mobile phone;
modifying the integrated media file to include actionable code, the actionable code soliciting one or more actions by a user of the mobile phone when playing the modified integrated media file; and
initiating delivery of a packet data unit via the messaging services protocol, the packet data unit encapsulating data enabling the modified integrated media file to be played on the mobile phone.

25. A method as in claim 24, wherein the packet data unit comprises the integrated media file.

26. A method as in claim 24, wherein the packet data unit comprises a URL pointing to a persisted version of the integrated media file, the URL, when activated, causing the integrated media file to be played on the mobile phone.

27. A computer-implemented method comprising:
receiving a request to initiate delivery of media content to a mobile phone;
obtaining the media content;
obtaining an advertisement associated with the request;
determining one or more content delivery specifications for the mobile phone;
combining at least a portion of the media content with at least a portion of the advertisement to generate an integrated media file, the integrated media file substantially conforming to the determined content delivery specifications for the mobile phone;
generating actionable code associated with the integrated media file, the actionable code soliciting one or more actions by a user of the mobile phone when playing the modified integrated media file; and
initiating delivery of data enabling the mobile phone to play the integrated media file with the actionable code to the mobile phone.

28. A computer-implemented method comprising:
receiving a request to initiate delivery of media content to a mobile phone;
determining one or more content delivery specifications for the mobile phone;
associating the content delivery specifications with a selected one of a plurality of previously generated integrated media files, the selected integrated media file comprising a combination of the media content and at least one advertisement, the selected integrated media file substantially conforming to the determined content delivery specifications for the mobile phone; and
initiating delivery of data enabling the mobile phone to play the integrated media file to the mobile phone.

29. A method as in claim 28, further comprising: generating actionable code associated with the integrated media file, the actionable code soliciting one or more actions by a user of the mobile phone when playing the modified integrated media file; and wherein the delivered data further comprises the actionable code.

30. A computer-implemented method as in claim 28, wherein the data comprises a URL pointing to the selected integrated media file.

31. A computer-implemented method as in claim 30, further comprising:
identifying the mobile phone by header information when the URL is selected;
determining whether the selected integrated media file is optimized for the identified mobile phone; and
delivering the selected integrated media file to the mobile phone if it is determined that the selected integrated media file is optimized for the identified mobile phone; or
associating the identified mobile phone with a second of the plurality of integrated media files if it is determined that the selected integrated media file is not optimized for the identified mobile phone, the second integrated media file being optimized for the identified mobile phone, and delivering the second integrated media file to the mobile phone.
